(19) United States
(12) Patent Application Publication
(10) Pub. No.: US 2024/0286908 A1
(43) Pub. Date: Aug. 29, 2024

(54) PROCESS AND APPARATUS FOR SCRUBBING A GAS STREAM

(71) Applicant: L'Air Liquide, Société Anonyme pour I'Etude et I'Exploitation des Procédés Georges Claude, Paris (FR)

(72) Inventors: Gian Luigi CALORO, Verneuil I'Etang (FR); Martin Raventos, Paris (FR); Francois Fuentes, Le Vesinet (FR)

(21) Appl. No.: 18/588,854

(22) Filed: Feb. 27, 2024

(30) Foreign Application Priority Data
Feb. 28, 2023 (FR) 2301845

(51) Int. Cl. C01B 32/50; B01D 47/00; B01D 53/14; B01D 53/18; B01D 53/60; B01D 53/78

(52) U.S. Cl. CPC C01B 32/50; B01D 47/00; B01D 53/1481; B01D 53/18; B01D 53/60; B01D 53/78; B01D 2252/103; B01D 2256/22; B01D 2257/302; B01D 2257/404; B01D 2258/0283; B01D 2259/652; C01B 2210/0003; C01B 2210/0071; C01B 2210/0075

(57) ABSTRACT

In a process for the scrubbing of a gas stream, liquid (7) from the scrubbing tower (K) is vaporized (E1) in order to cool ambient air (19) which is subsequently used to cool water (25), producing cooling water (27) to be used upstream or downstream of the scrubbing process.

### CROSS REFERENCE TO RELATED APPLICATIONS

This application claims the benefit of priority under 35 U.S.C. § 119 (a) and (b) to French Patent Application No. 2301845, filed Feb. 28, 2023, the entire contents of which are incorporated herein by reference.

### BACKGROUND

The present invention relates to a process and an apparatus for scrubbing a gas stream. The gas stream can be a gas at high temperature (typically at least 150° C., indeed even at least 180° C.), for example generated by combustion. It can also be at ambient temperature. It contains at least 15 mol % of carbon dioxide on a dry basis and is treated in order to recover the CO₂ and to prevent the latter from being discharged to the atmosphere.

Climate change constitutes one of the greatest environmental challenges. The increase in the concentration of carbon dioxide in the atmosphere is in very large part the cause of global warming. Man-made CO₂ is essentially emitted into the atmosphere by the combustion of fossil fuels in thermal power plants. Thermal power stations make it possible, by the combustion of fuels, to release heat which can used to produce steam and optionally mechanical or electrical energy. Combustion flue gases release significant amounts of CO₂ into the atmosphere. The combustion process results particularly in the production of flue gases comprising mainly CO₂, water, for example 30 mol % of water, gases resulting from the air, also called non-condensable gases (N₂, Ar, O₂), acid gases, called NOx and SOx, and significant amounts of dust.

During the treatment and purification stages, in particular the compression stage (followed by refrigeration), SOx and/or NOx, generic names which combine together all the sulfur oxides and all the nitrogen oxides, will generate acidic condensates, in particular: nitric acid, nitrous acid, sulfuric acid, sulfurous acid, and the like, which must be avoided in order to limit the risk of corrosion.

The aim of the scrubbing is to lower the temperature of the combustion gas, to knock out the matter suspended in it, for example dust, and the acid components contained in the combustion gas.

Depending on the composition of the combustion gas, the scrubbing can be carried out with water or water rendered basic by the addition of a base.

Basic wet scrubbing operations are a recognized technology in the treatment of flue gases for the removal of acid gases contained in flue gases. Sodium bases are preferred because they exhibit a good compromise between their performance qualities (solubility and thus ability to avoid precipitation) and their availability and associated cost. Mention may be made, for example, of: NaOH, Na₂CO₃, NaHCO₃, and the like.

The gas stream comprising at least one NOx and/or at least one SOx and at least 15 mol % of CO₂ on a dry basis enters countercurrentwise a tower acting as a gas/liquid contactor for basic wet scrubbing before exiting therefrom, at the top of the tower, enriched in CO₂ and having a reduced content of the at least one NOx and/or the at least one SOx. Caustic soda and/or water is sent to the top of the contactor to scrub the gas stream. At the foot of the gas-liquid contactor, the liquid which has been in contact with the stream is withdrawn. The liquid containing acidified water may also contain solid impurities (particles, such as dust contained in the combustion gas) and/or minerals dissolved in the liquid.

The gas stream exiting from the tower has a reduced content of NOx and/or SOx and is subsequently compressed in a compressor and dried in a dryer in order to be sent to a CO₂ separation unit in order to remove the nitrogen and the oxygen which it contains. This unit operates by partial condensation and/or by distillation, producing a fluid rich in CO₂. This fluid rich in CO₂ is sometimes pressurized before being used by a customer or sequestered. The unit also produces at least one gas enriched in nitrogen and/or in oxygen.

A closed-loop cooling water network is generally used to cool the gas originating from the contactor at the outlet of the compression stages of the compressor and upstream of the dryer.

The liquid exiting from the bottom of the scrubbing tower is generally treated in order to neutralize the harmful substances which it contains and is sent to a water treatment unit.

In particular, it can be treated by acid-base neutralization in order to remove the NOx and/or SOx which it contains.

JP 2015 137797 describes a process in which liquid from a flue gas scrubbing tower is pumped and sent to an evaporator.

The present invention consists in using the liquid exiting at the bottom of the scrubbing tower in order to cool water. The liquid is optionally treated in order to reduce the amount of suspended matter and dissolved minerals in it and is subsequently evaporated in an air stream at the inlet of the air coolers of a cooling water circuit in order to lower the temperature of the air and consequently to lower the temperature of the cold water produced by the air coolers. This cold water is subsequently used to cool a compressor of the CO₂ separation process, which is reflected by a reduction in the compression energy of the combustion gases from which it is desired to capture the CO₂.

### SUMMARY

One aim of the invention is to produce cooled air and cooled water with the bottom liquid from the scrubbing tower.

According to a subject-matter of the invention, there is provided a process for scrubbing a gas stream in which:
i) a gas stream comprising at least one NOx and/or at least one SOx and/or suspended matter and at least 15 mol % of CO₂ on a dry basis is sent to a scrubbing tower where it is cooled and scrubbed with water and/or with an alkaline liquid in order to produce a gas enriched in CO₂ at the top of the tower and a bottom liquid enriched in the at least one NOx and/or the at least one SOx and/or suspended matter at the bottom of the tower,
ii) at least a part of the bottom liquid is optionally filtered and/or demineralized in order to produce a purified liquid,
iii) at least a part of the bottom liquid of stage i) or the purified liquid of stage ii), if present, is used to cool an air flow by evaporation in direct contact or by indirect heat exchange, forming a cooled air flow, and
iv) the cooled air flow is used to cool a water flow by indirect or direct heat exchange, forming a cooled water flow.

According to other optional aspects of the invention, there is provided:
liquid from the scrubbing tower is vaporized in order to cool ambient air which is subsequently used to cool water, producing cooling water to be used upstream or downstream of the scrubbing tower,
at least a part of the bottom liquid of stage i) or the purified liquid of stage ii), if present, is pressurized by a pump upstream of stage iii),
the cooled water flow is used to cool a compressed gas between two stages of a compressor and/or after the last stage of a compressor by heat exchange, the compressor being a compressor
   i) of the gas stream upstream of the tower or
   ii) of the gas enriched in CO₂ withdrawn at the top of the tower or
   iii) of a product enriched in CO₂ produced by partial condensation and/or distillation of the gas enriched in CO₂ withdrawn at the top of the tower, this gas containing oxygen and/or nitrogen and/or carbon monoxide,
the at least a part of the bottom liquid is treated upstream of its vaporization in order to at least partially remove the at least one NOx and/or the at least one SOx and/or the suspended matter which it contains, the components removed being disposed of,
the at least a part of the bottom liquid of stage i) or the purified liquid of stage ii), if present, is stored in a storage facility upstream of the vaporization,
the at least a part of the bottom liquid of stage i) or the purified liquid of stage ii), if present, is not used to cool the air flow by evaporation if the ambient temperature is lower than a threshold and is stored in the storage facility if the ambient temperature is lower than the threshold,
the at least a part of the bottom liquid of stage i) or the purified liquid of stage ii), if present, is used to cool an air flow by evaporation only if the ambient temperature is greater than the threshold,
the liquid flow is vaporized by fogging or in adiabatic air coolers or in hybrid air coolers.

According to a subject-matter of the invention, there is provided an apparatus for scrubbing a gas stream comprising a scrubbing tower, optionally a treatment unit, optionally a storage facility, an evaporator, a heat-exchange means, means for sending a gas stream comprising at least one NOx and/or at least one SOx and/or suspended matter and at least 15 mol % of CO₂ on a dry basis to the scrubbing tower in order to cool it and to scrub it by means of water and/or of an alkaline liquid in order to produce a gas enriched in CO₂ at the top of the tower and a bottom liquid enriched in the at least one NOx and/or the at least one SOx and/or suspended matter at the bottom of the tower, means for exiting the bottom liquid from the tower, means for sending at least a part of the bottom liquid to the evaporator in order to be evaporated by direct or indirect heat exchange with an air flow, optionally after having treated the at least a part of the bottom liquid in the treatment unit in order to purify it and/or after having stored the at least a part of the bottom liquid in the storage facility, means for sending the air flow cooled in the evaporator to the heat-exchange means for indirect or direct heat exchange with a water flow to be cooled, forming a cooled water flow.

According to other optional aspects:
the apparatus comprises a pump for pressurizing the at least a part of the bottom liquid or the purified liquid, if present, upstream of the evaporator,
the apparatus comprises a treatment unit for treating the at least a part of the bottom liquid upstream of the evaporator in order to at least partially remove the at least one NOx and/or the at least one SOx and/or the suspended matter which it contains,
the apparatus comprises a storage facility for storing the at least a part of the bottom liquid or the purified liquid upstream of the evaporator,
the apparatus comprises means for regulating the dispatching of the at least a part of the bottom liquid or the purified liquid to the evaporator as a function of the ambient temperature.

An apparatus for the separation of a gas stream can comprise a scrubbing apparatus as described above, a compressor and an apparatus for separation by distillation and/or partial condensation connected to the scrubbing apparatus in order to separate the gas enriched in CO₂ forming a fluid product enriched in CO₂ with respect to the gas, means for sending the cooled water flow to cool the compressor, the compressor being a compressor
i) of the gas stream upstream of the tower or
ii) of the gas enriched in CO₂ withdrawn at the top of the tower or
iii) of a product enriched in CO₂ produced by partial condensation and/or distillation of the gas enriched in CO₂ withdrawn at the top of the tower.

The evaporation of the liquid from the tower can be carried out in different ways: fogging, in adiabatic air coolers, in hybrid air coolers of WSAC (Wet Surface Air Coolers) type.

Depending on the impurities contained in the condensates and depending on the quality of the water required for the item of equipment carrying out the evaporation, the treatment unit can include filtration, in order to reduce/remove suspended matter, and a demineralization line, in order to reduce/remove dissolved entities.

In all cases, the treatment unit will make possible the degassing of harmful gases dissolved in the condensates by sending them to the air through a chimney or to another secure place and thus avoiding the risk of poisoning for any operator who is to handle these effluents.

The liquid flow produced in the tower is typically not sufficient to ensure cooling by evaporation which is significant non-stop 24 hours a day. Thus, in order to have available a greater condensate flow, the liquid from the tower is stored, after optional treatment, in a tank. Only when the ambient temperature passes above a threshold, the liquid exits from the storage facility and is subsequently pumped to the evaporation system. In this way, the liquid produced during the night (and more generally during the coolest hours of the day) can be used during the day when the ambient temperature is highest and the need for cooling is greatest.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a process according to the invention.

### DETAILED DESCRIPTION OF PREFERRED EMBODIMENTS

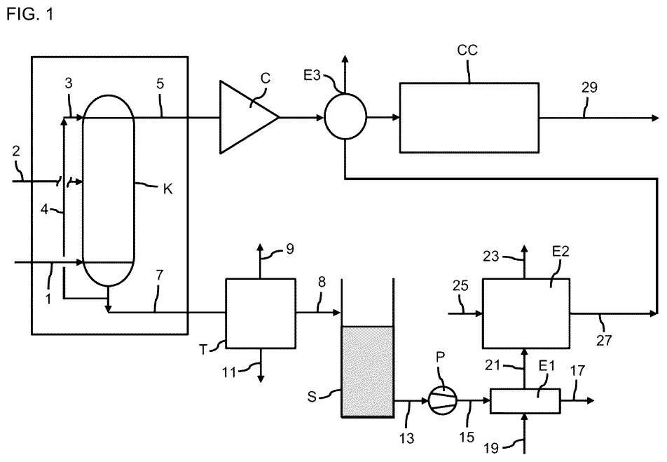

FIG. 1 shows a scrubbing process in which a gas 1 produced by combustion preferably contains at least 15 mol % of carbon dioxide, water, nitrogen and/or oxygen and/or argon and SOx and/or NOx and/or suspended matter, such as dust.

In this process of scrubbing a gas stream, liquid 7 from the scrubbing tower K is vaporized in the exchanger E1 in order to cool ambient air 19 which is subsequently used to cool water 25, producing cooling water 27 to be used upstream or downstream of the scrubbing process.

The hot combustion gas 1 is sent to a scrubbing tower K fed at the top by a flow of water 3 recovered in the bottom of the same tower and to which, if need be, caustic soda 2 is added. The gas 5, cooled and scrubbed from the SOx and/or NOx and/or suspended matter (dust), exits at the top of the tower. The scrubbing can be carried out at atmospheric pressure or else at a greater pressure, for example at least equal to 2 bar abs.

In the bottom of the tower, the part 7 of the liquid which is not recycled at the top of the scrubbing tower K is found enriched in SOx and/or in NOx and/or in suspended matter and can be sent to a treatment unit T where it is, for example, filtered, in order to remove the solid particles which it contains, and/or demineralized to a more or less high level depending on the level of demineralization required by the heat exchanger E1 where the evaporation takes place which cools the ambient air drawn in by the air coolers of the cooling water circuit.

The treated liquid 8 is preferably sent to a storage facility S, which can be a natural pool.

The liquid 11 at the outlet of the treatment unit T concentrates the SOx and/or the NOx and/or the suspended matter withdrawn from the treated liquid 8 and can be disposed of in accordance with the regulations in force.

If need be, through the outlet 9, the treatment unit T can also remove the possibly dissolved gases which it would not be desirable to have in the treated liquid 8. A chemical treatment, for example acid-base neutralization, makes it possible to remove the SOx and/or NOx which it contains.

From the storage facility S, the treated liquid 8 is pressurized as liquid 13 in a pump P forming a pressurized liquid 15. The liquid 15 is sent to a heat exchanger E1 (or evaporator) where it is evaporated by indirect or direct heat exchange with an air flow 19 which is cooled therein. Evaporation can take place by fogging by spraying the liquid 15 as fine droplets into the air. Alternatively, the exchanger E1 can comprise adiabatic air coolers operating by spraying or running the liquid into the air or in hybrid air coolers.

The water vapour 17 formed by evaporation of the water 15, for example by direct contact with the air 19, exits from the heat exchanger E1 and the air 21 cooled in the exchanger E1 is sent to a heat exchanger E2 where it cools a water flow 25 by direct or indirect heat exchange. The cooled water 27 is sent to a heat exchanger E3 where it cools the gas compressed in the compressor C, this gas being the overhead gas from the tower K. Thus the exchanger E3 acts as aftercooler of the compressor C. The water can also cool this compressor C at an interstage.

The heated air 23 exits from the exchanger E3.

The gas compressed in the compressor C is dried, cooled and separated by distillation and/or partial condensation in the separation unit CC to produce a flow rich in CO₂ 29. This makes it possible to remove the oxygen and/or the nitrogen and/or the argon and/or the carbon monoxide which it contains.

The flow rich in CO₂ 29 can be compressed in a compressor, which can be cooled after the final stage or in an interstage by the water 27.

Otherwise, the water 27 can cool a final stage or an interstage of the compressor of the gas stream 1 if the tower K operates under pressure.

Otherwise, the cooling water 27 can be used anywhere upstream or downstream of the scrubbing tower K.

In order to take advantage of colder ambient temperatures, the process can operate by storing cold liquid in the storage facility S. When the ambient temperature and/or the temperature of the air 19 is below a threshold, for example 15° C., at night or in winter, it is not necessary to send liquid (or such a large liquid flow) to the evaporator, since the air is already cold enough to cool the water in the exchanger E2 to the required temperature. Otherwise, in this case, it may be sufficient to send a reduced liquid flow, since the air is almost cold enough to cool the water to the temperature required in the exchanger E2.

Below this ambient temperature threshold, which can be measured by determining the outside temperature or that of the air 19, liquid is stored in a storage facility which is preferably thermally insulated. When the ambient temperature and/or the temperature of the air 19 rises above the threshold, for example 15° C., 30° C., it may be necessary to cool the air (or to cool the air more) and thus the liquid of the storage facility is withdrawn in order to be evaporated in the exchanger E1 (or a greater liquid flow is withdrawn in order to be evaporated in the exchanger E1 than during the period when the temperature is below the threshold).

The flow of vaporized liquid 17 originating from the storage facility S may be zero if the ambient temperature is sufficiently low. In this case, liquid is sent from the storage facility S to the exchanger E1 only if the ambient temperature is above a temperature threshold. Thus, the pump P only runs if the ambient temperature is above a temperature threshold, for example 15° C., 30° C.

In this case, the apparatus will comprise means for regulating the dispatching of the at least a part of the bottom liquid 7 or the purified liquid 13 to the evaporator E1 as a function of the ambient temperature.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for scrubbing a gas stream, in which:
i) a gas stream comprising at least one NOx and/or at least one SOx and/or suspended matter and at least 15 mol % of CO₂ on a dry basis is sent to a scrubbing tower where it is cooled and scrubbed with water and/or with an alkaline liquid in order to produce a gas enriched in CO₂ at the top of the tower and a bottom liquid enriched in the at least one NOx and/or the at least one SOx and/or suspended matter at the bottom of the tower,
ii) at least a part of the bottom liquid is filtered and/or demineralized in order to produce a purified liquid,
iii) at least a part of the bottom liquid of stage i) or the purified liquid of stage ii), if present, is used to cool an air flow by evaporation in direct contact or by indirect heat exchange, forming a cooled air flow, and
iv) the cooled air flow is used to cool a water flow by indirect or direct heat exchange, forming a cooled water flow.

2. The process according to claim 1, wherein the at least a part of the bottom liquid of stage i) or the purified liquid of stage ii), if present, is pressurized by a pump upstream of stage iii).

3. The process according to claim 1, wherein the cooled water flow is used to cool a compressed gas between two stages of a compressor and/or after the last stage of a compressor by heat exchange, the compressor being a compressor:
i) of the gas stream upstream of the tower (K) or
ii) of the gas enriched in CO₂ withdrawn at the top of the tower or
iii) of a product enriched in CO₂ produced by partial condensation and/or distillation of the gas enriched in CO₂ withdrawn at the top of the tower, the gas containing oxygen and/or nitrogen and/or carbon monoxide.

4. The process according to claim 1, wherein the at least a part of the bottom liquid is treated upstream of the vaporization in order to at least partially remove the at least one NOx and/or the at least one SOx and/or the suspended matter which it contains, the components removed being disposed of.

5. The process according to claim 1, wherein the at least a part of the bottom liquid of stage i) or the purified liquid of stage ii), if present, is stored in a storage facility upstream of the vaporization.

6. The process according to claim 5, wherein the at least a part of the bottom liquid of stage i) or the purified liquid of stage ii), if present, is not used to cool the air flow by evaporation if the ambient temperature is lower than a threshold and is stored in the storage facility if the ambient temperature is lower than the threshold.

7. The process according to claim 6, wherein the at least a part of the bottom liquid of stage i) or the purified liquid of stage ii), if present, is used to cool the air flow by evaporation only if the ambient temperature is greater than the threshold.

8. The process according to claim 1, wherein the liquid flow is vaporized by fogging or in adiabatic air coolers or in hybrid air coolers.

9. An apparatus for scrubbing a gas stream comprising a scrubbing tower, a treatment unit, a storage facility, an evaporator, a heat-exchange means, a means for sending a gas stream comprising at least one NOx and/or at least one SOx and/or suspended matter and at least 15 mol % of CO₂ on a dry basis to the scrubbing tower in order to cool it and to scrub it by means of water and/or of an alkaline liquid in order to produce a gas enriched in CO₂ at the top of the tower and a bottom liquid enriched in the at least one NOx and/or the at least one SOx and/or suspended matter at the bottom of the tower, a means for exiting the bottom liquid from the tower, a means for sending at least a part of the bottom liquid to the evaporator in order to be evaporated by direct or indirect heat exchange with an air flow, after having treated the at least a part of the bottom liquid in the treatment unit in order to purify it and/or after having stored the at least a part of the bottom liquid in the storage facility, a means for sending the air flow cooled in the evaporator to the heat-exchange means for indirect or direct heat exchange with a water flow to be cooled, forming a cooled water flow.

10. An apparatus according to claim 9, comprising a pump for pressurizing the at least a part of the bottom liquid or the purified liquid, if present, upstream of the evaporator.

11. An apparatus according to claim 9, comprising a treatment unit for treating the at least a part of the bottom liquid upstream of the evaporator in order to at least partially remove the at least one NOx and/or the at least one SOx and/or the suspended matter which it contains.

12. An apparatus according to claim 9, comprising a storage facility for storing the at least a part of the bottom liquid or the purified liquid upstream of the evaporator.

13. An apparatus according to claim 9, comprising means for regulating the dispatching of the at least a part of the bottom liquid or the purified liquid to the evaporator as a function of the ambient temperature.

14. An apparatus for the separation of a gas stream comprising a scrubbing apparatus according to one of claim 9, a compressor and an apparatus for separation by distillation and/or partial condensation connected to the scrubbing apparatus in order to separate the gas enriched in CO₂ forming a fluid product enriched in CO₂ with respect to the gas, a means for sending the cooled water flow to cool the compressor, the compressor being a compressor:
i) of the gas stream upstream of the tower or
ii) of the gas enriched in CO₂ withdrawn at the top of the tower or
iii) of a product enriched in CO₂ produced by partial condensation and/or distillation of the gas enriched in CO₂ withdrawn at the top of the tower.
